(19) United States
(12) Patent Application Publication
(10) Pub. No.: US 2019/0132372 A1
(43) Pub. Date: May 2, 2019

(54) SYSTEM AND METHOD FOR DISTRIBUTION AND SYNCHRONIZED PRESENTATION OF CONTENT

(71) Applicant: Gala Prompter Ltd., Herzliya (IL)

(72) Inventors: Elena LITSYN, Tel Aviv (IL); Hagai PIPKO, Herzliya (IL)

(73) Assignee: Gala Prompter Ltd., Herzliya (IL)

(21) Appl. No.: 16/092,775

(22) PCT Filed: Mar. 6, 2017
(86) PCT No.: PCT/IL2017/050422

§ 371 Date: Oct. 11, 2018

Related U.S. Application Data
(60) Provisional application No. 62/322,905, filed on Apr. 15, 2016.

(51) Int. Cl. H04L 29/06; H04L 29/08

(52) U.S. Cl. CPC H04L 65/4076; H04L 67/306; H04L 67/18; H04L 67/12

(57) ABSTRACT

A method of dynamically pacing the presentation of pre-recorded supplementary content to synchronize to live content at a live event, comprising providing the pre-recorded supplementary content associated with the event to end-user devices, with an ordered sequence of content items, each timed to be played on the end-user devices sequentially according to a predefined presentation time duration, and each associated with a scripted property, receiving real-time sensor data from sensors in a facility measuring a property of the live event, matching the measured property of the live event with a corresponding scripted property to identify a live progress of the event indicated by a progress indicator, and sending the indicator to the end-user devices to synchronize the timing of the measured properties of the live event with the timing of the content item associated with the matching scripted property.

### FIELD OF THE INVENTION

Embodiments of the present invention relate generally to media players and displaying supplemental media content thereon that is substantially synchronized to primary live content. More particularly, embodiments of the present invention relate to systems and methods for the presentation of supplemental media content, such as subtitles or audio translations on media players such as portable computing devices, synchronized with live primary content, such as a performance, at a live or real-time event.

### BACKGROUND OF THE INVENTION

Various gatherings of mass audiences, such as live entertainment events, political forums or educational lectures, may require distribution of supplementary media content regarding the event for some members of the audience. For example, some members of an audience may require reading subtitles simultaneously with the occurring event due to language translation issues or hearing impairment, e.g. during a theater performance, university lecture, political debate, etc.

In order to provide such supplementary media content to the audience, a predefined set of client devices may be used along with a single source device that transmits the supplementary content to the client devices. For example, a theater performance with real-time translation may use dedicated client devices that provide visual translation, such as subtitles, and/or audio translation, such as audio tracks translating the performance into the listener's native language. The dedicated client devices may be queued to play supplementary content according to a predefined timeline based on the time that has elapsed during the event. However, if live performers deviate from the predefined timeline, even slightly, the supplementary content may be de-synchronized from the real-time live performance, creating significant difficulties in understanding.

There is therefore a longstanding need inherent in the art to provide real-time adjustments to dynamically pace the flow of pre-recorded supplemental content to synchronize to live performance content having variable or unpredictable timing.

### SUMMARY OF THE INVENTION

There is provided, in accordance with some embodiments of the invention, a method of dynamically pacing the presentation of pre-recorded supplementary content to synchronize to live content at a live event, the method comprises in one or more processor(s) providing the pre-recorded supplementary content associated with the event to one or more end-user devices, wherein the pre-recorded supplementary content comprises an ordered sequence of content items, each timed to be played on the one or more end-user devices sequentially according to a predefined presentation time duration, and each associated with a scripted property; receiving real-time sensor data from one or more sensors in a facility measuring a property of the live event; matching the measured property of the live event with a corresponding scripted property to identify a live progress of the event indicated by an event progress indicator; and sending, via a network, the event progress indicator to the one or more end-user devices to synchronize the timing of the measured properties of the live event with the timing of the pre-recorded supplementary content item associated with the matching scripted property.

According to some embodiments, the real-time sensor data may be received every predefined time interval.

According to some embodiments, the time interval may be shorter than the predefined presentation duration of each content item of the ordered sequence of content items.

According to some embodiments, each of the at least one sensor may be one of a list consisting: an audio sensor, a light sensor, an image sensor, a motion sensor, and a positioning sensor.

According to some embodiments, providing of the pre-recorded supplementary content associated with the event to one or more end-user devices may comprise identifying that the at least one end-user device associated with the event is in proximity to the facility, and downloading the pre-recorded supplementary content associated with the event to the at least one end-user device.

According to some embodiments, the downloaded supplementary content may be automatically removed from each of the at least one end-user devices based on the progress of the event.

According to some embodiments, the supplementary content associated with the event is one or more supplementary content selected from a list consisting: subtitles in one or more languages, dubbing to one or more languages, and enhanced sound.

According to some embodiments, the method further comprises receiving a selection of supplementary content from at least one end-user device; identifying a location of each of the at least one end-user device; determining preferences of at least one user associated with the at least one end-user device, based on the event, the selected type of supplementary content and the end-user device location; and presenting suggested content according to the determined preferences, the identified location and the live progress of the event.

According to some embodiments, presenting suggested content may be further according to the at least one user preference history and location history.

According to some embodiments, the method further comprises assigning an input channel for each sensor; assigning at least one cue to portions of each content item; associating each cue with an input channel; and initiating presentation of a portion upon receiving a cue corresponding to said portion

According to some embodiments, the method further comprises checking input channel associated with a consecutive cue if the duration of the presentation is longer than a predefined minimal presentation time.

According to some embodiments, the method further comprises switching to presentation of a different portion when consecutive cue is received.

Furthermore, in accordance with an embodiment of the present invention, a system for dynamically pacing the presentation of pre-recorded supplementary content to synchronize to live content at a live event in at least one event facility may comprise at least one event facility computing device; at least one sensor located at the event facility; and a cloud server in active communication with the one or more facility computing devices and connectable, via a network, to a plurality of end-user devices associated with an event to take place at one of the at least one facility. In some embodiments, the cloud server may comprise a first database configured to store at least one of the pre-recorded supplementary content, and a controller configured to provide the pre-recorded supplementary content associated with the event to one or more end-user devices, wherein the pre-recorded supplementary content comprises an ordered sequence of content items, each timed to be played on the one or more end-user devices sequentially according to a predefined presentation time duration, and each associated with a scripted property. In some embodiments, each of the one or more facility computing devices, may comprise a first processor configured to receiving real-time sensor data from one or more sensors in the facility measuring a property of the live event; matching the measured property of the live event with a corresponding scripted property to identify a live progress of the event indicated by an event progress indicator; and sending, via a network, the event progress indicator to the one or more end-user devices to synchronize the timing of the measured properties of the live event with the timing of the pre-recorded supplementary content item associated with the matching scripted property.

According to some embodiments, each of the at least one sensor may be one of a list consisting: an audio sensor, a light sensor, an image sensor, a motion sensor, and a positioning sensor.

According to some embodiments, the server computer may further comprise a second database, the second database configured to store suggested content.

According to some embodiments, the suggested content may comprise one or more of: proposals for purchasing event related merchandise; proposals to purchase tickets to other events; advertisements and coupons.

According to some embodiments, the server computer may be configured to receive from the one or more end user devices location information, and determine preferences of the at least one user, based on the event to which the end-user device of the at least one user is associated to, the supplementary content selected via the at least one end-user device, and the location of the at least one end-user device; and presenting the suggested content according to the determined preferences, the identified location and the live progress of the event.

According to some embodiments, the facility computing device may comprise an input device configured to receive manual event progress indicators.

According to some embodiments, the cloud server may be in active communication with at least two facility computing devices, each of the at least two facility computing devices is located in a different event facility.

According to some embodiments, an input channel may be assigned to each sensor, and the presentation may be initiated upon receiving a signal from at least one input channel wherein an input channel is assigned to each sensor, and wherein presentation is initiated upon receiving a signal from at least one input channel.

Accordingly, there is hereby provided a system and method to overcome the longstanding need inherent in the art for providing real-time adjustments to dynamically pace the flow of pre-recorded supplemental content to synchronize to live performance content having variable or unpredictable timing.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows high level block diagram of an exemplary computing device, according to an exemplary embodiment of the invention;

FIG. 2 schematically illustrates a system for distribution and synchronized presentation of content, according to an exemplary embodiment of the invention;

FIG. 3 is a flowchart of a method of distribution and synchronized presentation of content, according to an exemplary embodiment of the invention;

FIG. 4 is a flowchart of a method of synchronizing the display of content item portions to an occurring event in real time, according to some embodiments of the present invention; and

FIG. 5 is a flowchart of a method of synchronizing the display of content item portions to an occurring event in real time, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

According to some embodiments, systems and methods are provided for distribution of media content supplementing live content and the synchronization of the supplemental media content to the live content. According to some embodiments of the invention, an administrator or manager may use a website or dedicated software to upload the supplemental media content to a centralized server (e.g., a cloud-based server or servers). The centralized server may receive input from the user to customize the content such as the data content, content quality such as audio quality for audio transcription or aspect ratio for visual transcription, and/or content flow or speed. In one example, the server may receive the user-input via a virtual “green room” provided by software mimicking a staging area. The user customization may be provided dynamically in real-time e.g. during the live event, or offline before the live event. A media player may play the customized content for end users, for example subtitles in opera or movie theaters, song lyrics for karaoke, or presentations during a high school class. In some embodiments, the computerized device may automatically detect the start of the event or the start of sub-parts of the event (e.g. scenes in a play, the end of intermission, sections of a lecture, etc.) as temporal markers to which the supplemental content is synchronized, for example, such that the supplementary content commences automatically. In some embodiments, the computerized device may automatically detect the type of event from predefined set of event templates or pre-stored events, for example, based on various parameters such as geographical location, time, and date (e.g. detected by the computerized devices' GPS and clock), audio type (e.g., music event vs. lecture), user parameters (e.g. to customize the content for the individual user). The manager may control the supplemental media content provided to the end users with a “front-end” graphical user interface (GUI), and may optionally delete the data from the central server or the individual end-user devices remotely after the live event is finished. In another embodiment, the supplemental media content may be merged with a recording of the live event in a file for later playback as a recorded past event.

In one embodiment, an end user may install a dedicated presentation and synchronization program or code, e.g. executable on a portable computerized device (such as a smartphone), and operate that program or code to receive (e.g. by downloading from a web based server) real-time subtitles or supplementary visual content (e.g. pictures) during an event (e.g. opera show or a university lecture).

According to some embodiments, the dedicated presentation and synchronization program may provide generic support for a variety of content and providers, such that the same program executable on a computerized device may be operated at different events and at different countries. For example, watching a theater play in France with German subtitles appearing in real-time on a computerized device of the user, wherein different users may require subtitles in different languages. Such embodiments distinguish some currently available solutions in which a single translation is provided for the entire audience, and wherein translations in multiple different languages is not possible.

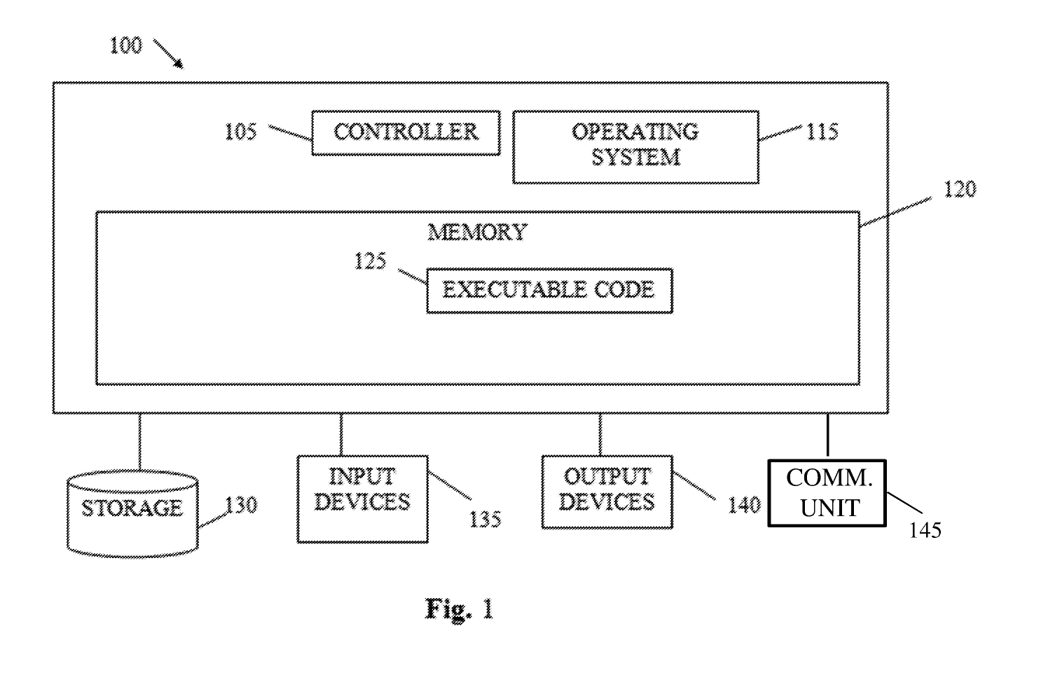

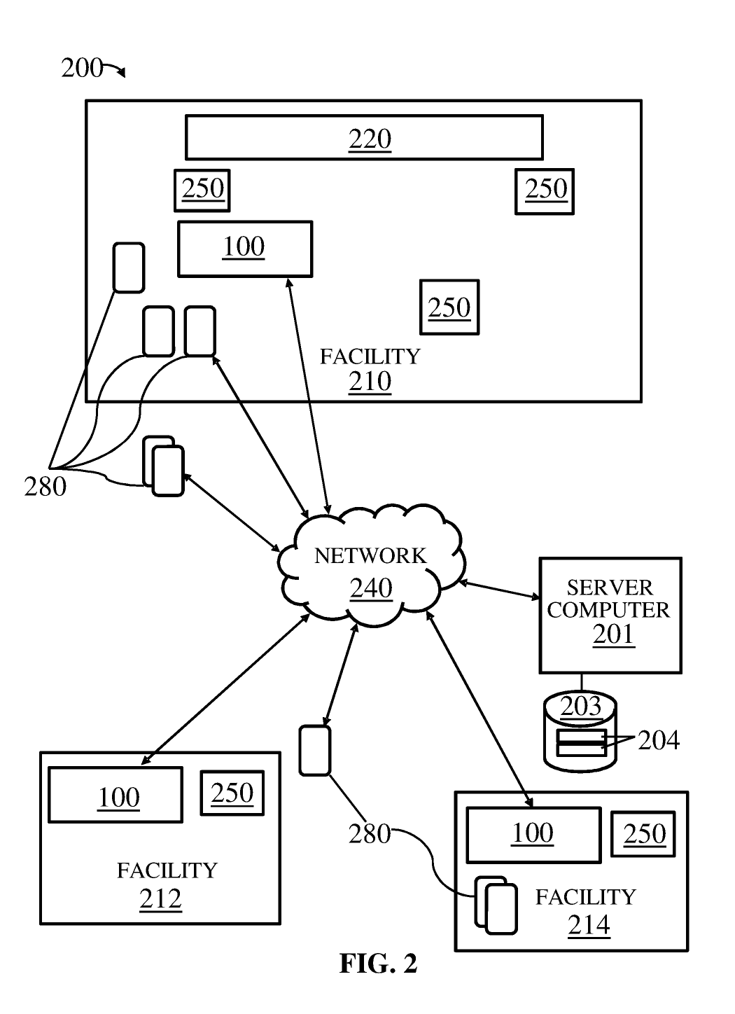

Reference is made to FIG. 1, which is a schematic block diagram of an example computing device, according to some embodiments of the invention. Computing device 100 may include a controller or processor 105 (e.g. a central processing unit processor (CPU), a chip or any suitable computing or computational device), an operating system 115, memory 120, executable code 125, storage 130, input devices 135 (e.g. a keyboard, touchscreen, and/or one or more sensors, such as microphones, light sensors, motion sensors, positioning sensors, image sensor or any other suitable sensor known in the art), and output devices 140 (e.g. a display), a communication unit 145 (e.g. a cellular transmitter or modem, a Bluetooth communication unit, a Wi-Fi communication unit, an Infrared (IR) communication unit, or the like) for communicating with remote devices via a communication network, such as, for example, the Internet. Controller 105 may be configured to execute program code to perform operations described herein. The system described herein may include one or more computing device(s) 100, for example, to act as the various devices or the components shown in FIG. 2. For example, system 200 may be, or may include computing device 100 or components thereof.

In some embodiments, controller 105 may execute code 125 stored in memory 120, to carry out a method of distribution of media content supplementing live content and the synchronization of the supplemental media content to the live content, for example, during the event's occurrence, substantially in real-time. For example, controller 105 may be configured to receive data captured by one or more input devices such as sensors 135, such as for example, audio samples, light samples, temporal data from a clock, or any other data from a live event that may be indicative of the progress of the event. Controller 105 may use the collected sensor data (e.g. time or duration, sound, light levels, etc.) to create an event progress indication (e.g. indicating which specific scene or part of an event is currently being performed). Additionally or alternatively, the progress indicator may be received manually via other input devices 135 such as a keyboard or a touchscreen. Controller 105 may apply one or more voice recognition algorithm(s) and one or more voice-to-text algorithm(s) to create a textual translation of audio occurring in the event. According to some embodiments, controller 105 may priorities some inputs over other inputs based on a priority list, such as, for example: a) manual cues; b) audio signals received from on stage microphones (e.g. identifying strength of the signal in a microphone and determining switches between microphones, detection of number of speakers on stage, speaker gender recognition etc.); c) speech recognition, including specific key words recognition d) phonemes, specific sounds and music recognition; and the like. It should be appreciated that inputs of hierarchy may have a higher weight in determining the actual timing for switching presented content, than inputs of lower hierarchy. Controller 105 may use the event progress indication to search a pre-stored script for the current textual data and may compare the extracted textual translation to the pre-stored script. According to some embodiments, when a discrepancy occurs between the current textual data and the pre-stored script, a partial correlation check may be conducted, e.g. by searching for keywords from the current textual data in the pre-stored script and determining a correlation ratio. According to some embodiments, when the correlation ratio is higher than a predefined threshold, the current textual data may be defined as matching the pre-stored script. According to some embodiments, for each segment of the pre-stored script, a predefined list of keywords may be associated and stored. In addition, according to some embodiments, for each keyword, one or more synonyms may be defined and stored in storage, such as storage 130. According to some embodiments, when the current textual data does not match the pre-stored script, a search of keywords and synonyms may be performed in order to find sufficient correlation (e.g. a correlation ratio above a predefined threshold). It should be appreciated that the search of matching script should be performed only in portions of the script not yet identified as matching a previous textual data stream. For example, if the pre-stored script is divided into five segments, and the first three segments have been already correlated to textual data from the currently occurring event, current textual data may only be compared to the two remaining segments of the script (i.e. the fourth and fifth segments).

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad, one or more sensors or any other or additional suitable input device. Any suitable number of input devices 135 may be operatively connected to computing device 100. Output devices 140 may include one or more displays or monitors, speakers, earphones or headphone jacks and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets, smart watches and the like.

Reference is made to FIG. 2, which is a schematic block diagram of a system 200 for distribution of media content supplementing live content and the synchronization of the supplemental media content to the live content, according to some embodiments of the invention. In FIG. 2, the direction of arrows indicates one example of the direction of information flow. System 200 may include one or more server computer(s) 201, such as a cloud server. Server computer 201 may be operatively connected, for example, via a network 240 such as the Internet, to one or more facility computing devices 100 in one or more facilities 210, 212, 214. In some embodiments, server computer 201 and facilities 210, 212, 214 may be operatively connected to network 240 via wireless communication.

Server computer 201 may include some or all components of computing device 100 described with reference to FIG. 1. For example, according to some embodiments, server computer 201 may include a controller such as controller 105 that may be, for example, a central processing unit processor (CPU), a chip or any suitable computing or computational device, operating system 115, memory 120, an executable code 125, storage 130, input devices 135 that may be, for example, a keyboard, a touchscreen, a mouse, a keypad, or any other suitable input device, as described in reference to FIG. 1.

According to some embodiments, server computer 201 may include a content database 203 configured or designed to store supplementary media content items 204 providing supplementary content associated with one or more live events. According to some embodiments, supplementary media content item 204 may include: subtitles in one or more languages, dubbing tracks in one or more languages, enhanced sound for the hearing impaired, and other content that supplements live content. Supplementary media content item(s) 204 may be stored in content database 203, and may be organized in content folders. In some embodiments each content item 204 may be divided into one or more portions or parts, such as, for example, slides, data blocks, or files.

Each supplementary media content item 204 portion may be associated with a different portion of an event or performance. For example, when content item 204 is English subtitles of the opera ‘La Traviata’, the translated script of the opera may be divided into data blocks such as sentences or phrases, so that each data block may be referred to as a different portion of content item 204 and may be stored as a separate slide or file. Each file or slide, including, for example, one sentence of the English subtitles of ‘La Traviata’, is associated with a different portion of the event and may be assigned, according to some embodiments, a scripted progress indicator that represents, for example, a predefined time during an event that each specific content item portion (such as a specific subtitles slide) should be played.

In some embodiments, a predefined ordered sequence of the supplementary media content items 204 portions (e.g. presentation slides) may be queued and played sequentially such that each supplementary media content item 204 portion (e.g. a subtitle slide for a theater play) may be played for a predefined presentation time duration (e.g. a single duration for all content items such as 4 seconds per slide, or different durations for at least some different content items depending on the length of content in the item portion). In case the occurring live event (e.g. theater show) deviates from that predefined timing (e.g., the live or real-time event progress indicator differs from the scripted progress indicator), a corresponding real-time deviation of the playback schedule may be presented to the user to synchronize media playback with the live event progress indicator. For example, if an actor in a theater play takes 7 seconds to pronounce a sentence that was predefined to last 5 seconds, an audio sensor may automatically detect the deviation and facility computing device 100 may activate a corresponding deviation in the presentation of the successive slides to the users (to be delayed by 2 seconds). In some embodiments, for example, when a live performer is reciting dialogue slower than is scripted, facility computing device 100 may pad the time of content item 204 or portion by appending data with blank or silent content. In other embodiments, the duration of the audio or subtitles may be stretched to extend their recitation or display from 5 to 7 seconds (e.g. audio may be processed to adjust playback time without altering pitch). In some embodiments, for example, when a live performer is progressing slower than is scripted due to ad-libbing or deviation from the script, the system may append or edit the scripted content item 204 with the live content transcribed from voice-to-text (e.g. as live edited subtitles) and/or text-to-speech (e.g. as live edited dubbing).

According to some embodiments, each facility computing device 100 may be operatively connected to one or more sensors 250 located in each facility 210, 212, 214. Sensors 250 may be, according to some embodiments, one or more of an audio sensor, such as a microphone, an image sensor, such as a camera or video recorder, a motion sensor, a light sensor, or any other sensor suitable for collecting data related to the progress of an event taking place in facility 210, 212, 214. Computer 100 may use each type of sensor, e.g. light, motion, audio, image, to monitor the progress of the live event by comparing the sensed parameter changes (e.g., live sensed audio or lighting sequences) with scripted parameter changes (e.g., scripted audio or lighting sequences) and may adjust for any timing deviations therebetween. In the example of monitoring lighting, light sensor(s) may be attached e.g. to stage lights, or a central lighting board monitoring analogue or digital controls on the board itself or a connected computer. Deviations between the sensed live lighting and the scripted lighting cues may be used to detect when the real-time event progress indicator differs from the predefined or scripted progress indicator. In some embodiments, a combination of sensors may be used to determine the real-time event progress indicator. For example, the real-time event progress indicator is defined or adjusted by a combination of audio and lighting timing markers. In another embodiment, audio may be the primary sensor parameter used to pace the real-time event progress indicator, but which at least a portion of the timing adjustments due to audio (e.g. adjustments which have a below threshold confidence value due to noise or other uncertainties) are verified using queues from another sensor parameter, such as, motion, light or visual parameter queues. According to some embodiments, sensor or sensors 250 may be located proximate to a stage 220, sound room, or any other area of facility 210, 212, 214 in which an event, or performance is to be performed live, or may be directed towards stage 220 or any other area of facility 210, 212, 214 in which an event is to take place in order to allow sensor or sensors 250 to capture or collect signals, such as a stream of images, a sound sample, light changes or motion occurring on, for example, stage 220, that may be indicative of the progress of the event or performance. In some embodiments, indications regarding the progress of an event may additionally or alternatively be received manually via user input device 135 such as a keyboard of facility computing device 100. According to some embodiments, sensors 250 may include one or more wearable microphones configured to receive audio signals from a performer or actor wearing the microphone. Audio signals received from each wearable microphone may be associated with a specific performer or character when compared to a script.

An event, according to embodiments of the present invention, may be a theater play, an opera, a concert, a musical, a sporting event, a lecture, a political or diplomatic event, or any other performance before an audience of one or more viewers. Facility 210, 212, 214 may be any area or location in which an event may be held, such as, for example, a concert hall, a theater, a stadium, or the like.

According to some embodiments, facility computing device 100 may continuously or repeatedly receive readings or signals from one or more sensors 250 and apply sound recognition algorithms, voice to text algorithms, image analysis algorithms and the like, in order to identify the progress of an event or performance in substantially real-time and send an event progress indicator to server computer 201, substantially in real-time. Real-time may refer to a time interval of less than 0.1 second; substantially real-time may refer to a time interval of less than 1 second.

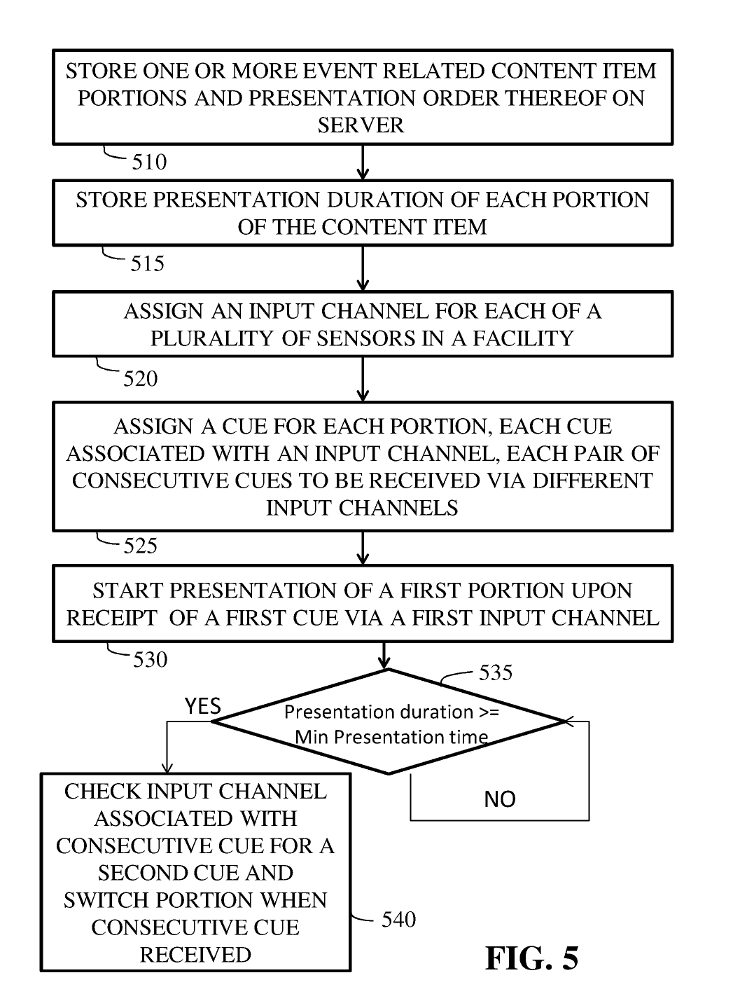

According to some embodiments, event progress indicator may be the measured or observed time that elapsed from the beginning of an event or from another reference point (e.g. from the end of the second act, third scene etc.), a scene number or an instant of the event, to a current or present time, as measured by controller 105 using an internal or external clock of computing device 100. Other progress indicators may be used. For example, sound sensor 250 in facility 210, may send to facility computing device 100 a sound sample, for example, two seconds long sound sample continuously or every predefined time interval (e.g., every ten seconds). A sound analysis algorithm applied to the sound sample(s), may identify a segment of the event, or a specific cue (such as a word, a tune or sound effect) that may be indicative of a specific instant of the event. For example, at the beginning of a show, some of the lights in facility 210, 212, 214 may be turned off while other lights (e.g. stage lights) may be turned on. Indications received from a light sensor located on stage may thus indicate that a show is about to start. A microphone worn by the opening actor may provide audio signals that are indicative that the play has started. Similarly, pauses in a monologue, changes in speakers in a dialogue and the like may indicate the progress or provide timing markers of the occurring event, as further detailed with reference to FIG. 5 herein. According to some embodiments, controller 105 (of FIG. 1) of facility computing device 100 may identify a specific cue, compare the identified cue to pre-stored cues or segments, stored, for example, on storage 130 (of FIG. 1) and based on the comparison, determine or identify an event progress indicator. According to another example, sensor 250 may be a light sensor, and may provide to controller 105 of computing device 100 a lighting signal periodically or every time a change in illumination on stage 220 is sensed. Controller 105 may compare the received signals with a pre-stored timeline of illumination changes for the specific event, and thus may determine an event progress indicator based on the signals received from light sensors 250. According to some embodiments, a plurality of different sensors 250 may be used in order to improve the accuracy of the determination or identification of the progress of the event. For example, one or more of a light sensor, a sound sensor and a camera may be used in order to receive sound cues, light changes and/or stage images or video.

According to some embodiments, one or more server computers 201 may be in active communication with one or more portable or mobile computerized end-user devices 280, such as a laptop computer, a tablet, a smartphone or the like, via a communication network 250, such as the Internet. Such portable or mobile devices 280 may serve as an input and/or output device for devices 100 and/or server computer 201.

According to some embodiments, server computer 201 may transfer (e.g. download or stream via the Internet, or a local wireless network, such as a WLAN) to end-user devices 280 a content item 204 according to an event to which devices 280 are associated, according to the location of devices 280 (e.g. in proximity to an event facility such as facility 210), a selection of a user of each of devices 280, and the like. According to embodiments of the present invention, a device 280 may be associated to an event when a user of the device provides an indication that he or she intends to participate in the event. For example, when a user purchases a ticket to an opera, the user may be required to provide indications regarding devices 280 that should be associated to the event, for example by providing a cellular phone number associated to device 280, or, for example, by providing via a dedicated application installed on each of devices 280 a request to be associated with an event, an indication such as a ticket number or a selection of an event from a list of events, or in any other manner suitable for associating devices 280 to an event.

According to one embodiment, each content item may be temporarily downloaded or streamed by server computer 201 to one or more devices 280, and may be removed or deleted automatically, for example, after the event ends, when device 280 is no longer within a predefined distance from an event facility such as facility 210, and/or after a predefined time period. For example, devices 280 may belong to individual event viewers which are not permitted to store viewed content outside of the event venue. Content items 204 may immediately or periodically delete from devices 280 after viewing, stored only in buffer but not long-term memory, or may delete after a predetermined amount of time. In one embodiment, upon an attempt to access content items 204, device 280 may use a location tracking device such as a GPS to determine its location, and upon detecting that the location of device 280 is outside of a permissible radius of the event (e.g. outside of the venue), may delete of block playback of content items 204. Other conditions for removing the content items 204 from devices 280 may be used.

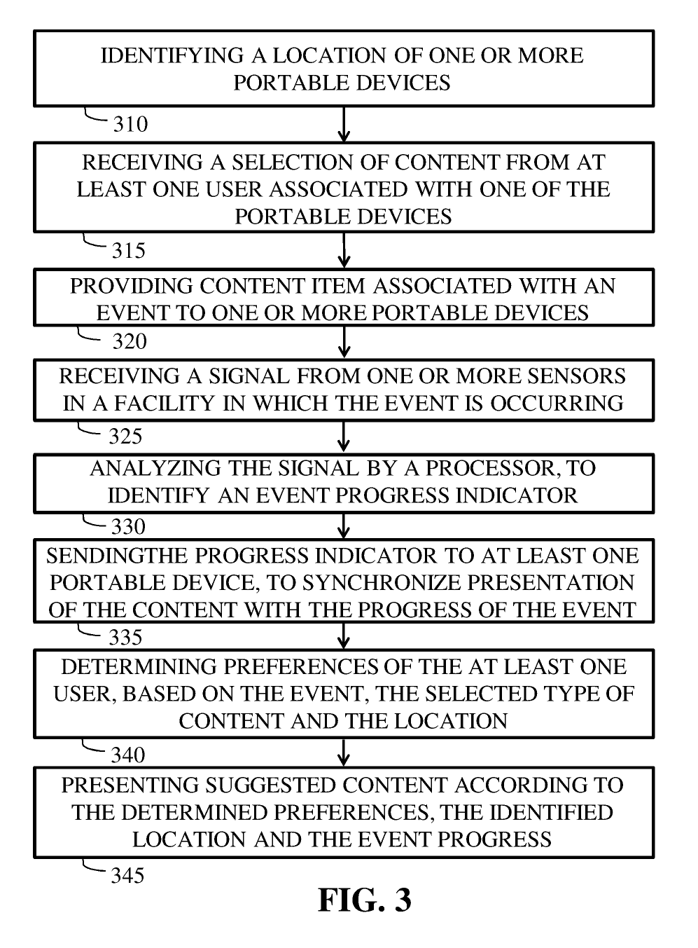

Reference is made to FIG. 3, which is a flowchart of a method for distribution of media content supplementing live content and the synchronization of the supplemental media content to the live content, according to embodiments of the present invention. According to some embodiments, various steps may be optional.

In block 310, according to some embodiments, a server computer (e.g., server computer 201 of FIG. 2), such as a cloud server, may identify the location of each device (e.g., device 280 of FIG. 2) associated with or registered to an event, and may provide a content item (e.g., content item 204 of FIG. 2) associated with the event to which each device is associated, to the device, for example, when the device (and thus the user thereof) is identified to be within a predefined distance from the facility in which the event is to take place. According to some embodiments, the content item may be provided to the device (e.g. downloaded or streamed) only in real-time or at a predefined time period prior to the expected start time of the event (e.g. half an hour prior to the beginning of the event). According to some embodiments downloading or providing the content item may be initiated only when the device is within a predefined distance from the facility and a predefined time period prior to the expected start time of the event. Other conditions for initiating downloading of a content item to the device may be used.

According to some embodiments, downloading of content items to a device may be temporary, and each content item may be removed or deleted automatically, for example, after the event ends, when the device is no longer within a predefined distance from an event facility, and/or after a predefined time period. Other conditions for removing the content item from a device may be used.

As seen in block 320, a method according to embodiments of the present invention may include providing (e.g. downloading or streaming via the Internet or a local wireless network) one or more content items associated with an event, such as a play, an opera, a concert, or any other event, to one or more portable or mobile computerized end-user devices associated with the event, such as a smartphone, a tablet computer, a laptop and the like. A portable or mobile computerized device may be associated with an event via an application installed on the device. According to some embodiments, a device may be associated to an event by registering the device via a webpage login or by scanning a digital barcode or a Quick Response (QR) code printed on a ticket to the event on the device screen, or by any other method known in the art.

According to some embodiments, the content item to be provided to each device may be determined according to the available content items for the event, a selection by the user (block 315), user's selection history (e.g. recording that the user usually downloads English subtitles to all events that are not in the English language), and the like.

In blocks 325 and 330, a processor of the facility computing device may receive a signal from one or more sensors, such as one or more audio sensors, light sensors, image sensors, and/or motion sensors located in a facility in which an event is taking place, and analyzing the received signals by a processor (such as controller 105 in FIG. 1), to identify the progress of the event, for example, by applying sound recognition algorithms, voice to text algorithms, image analysis algorithms and the like, in order to identify the progress of an event or performance in substantially real-time and send an event progress indicator to the server computer, substantially in real-time. According to some embodiments, event progress indicator may measure (e.g. using a clock) the time duration that elapsed from the beginning of an event or from another reference point (e.g. from the end of the second act, third scene etc.), a scene number or an instant of the event, to a current or present time, as identified by the controller of the facility computing device.

Controller 105 (in FIG. 1) may apply a sound analysis algorithm to the sound sample(s), identify a segment of the event, or a specific cue (such as a word, a tune or sound effect) indicative of a specific instant of the event. According to some embodiments, controller 105 (in FIG. 1) of facility computing device 100 may identify the specific cue, compare the identified cue to pre-stored cues or segments, stored, for example, on storage 130 (in FIG. 1) and based on the comparison, determine or identify an event progress indicator (e.g. an absolute or relative measure of the timing of pacing of the live event). According to one embodiment, sensor 250 may be a light sensor, and may provide to controller 105 of computing device 100 a signal periodically or every time a change in illumination on stage 220 is sensed. Controller 105 may compare the received signals with a pre-stored timeline of illumination changes for the specific event and thus may determine an event progress indicator based on the signals received from light sensors 250.

According to some embodiments, a plurality of different sensors 250 may be used in order to improve the accuracy of the determination or identification of the progress of the event. For example, a light sensor, sound sensor and a camera may be used in combination in order to receive sound cues, light changes and stage images or video. According to some embodiments, the signals from the sensors are received periodically, for example, every predefined time interval, such as, every 0.1 second, 1 second, seconds, or other predefined time. According to some embodiments, each portion of the content item may have predefined presentation duration (e.g., 5 seconds) and the time interval between readings received from the sensors (e.g., 1 second) may be shorter than the predefined presentation duration of each portion of the content item.

According to some embodiment, the event progress indicator may be sent to a server computer, which in turn may send an indication to one or more portable or mobile devices associated with an event, to synchronize the presentation of each portion of the content item to the current occurrence on stage or to the correct instant of the event (as seen in block 335). Alternatively, the event progress indicator may be sent directly to the end-user devices to synchronize the content items.

According to some embodiments, the server computer 201 and/or user devices 280 may identify the location of each of the end-user devices associated with or registered to one or more events, determine the preferences of at least one user, based on the event to which the portable device of that user is associated, based on the type of content item selected by the user (e.g. subtitles in English) and the location of the portable device (block 340), and may present or propose suggested content to the user (block 345), that may suit the user's preferences, other events that are taking place before or after the event to which the device is associated, and within a predefined distance from the event facility.

For example, when a user's portable device is associated with an opera that is taking place at the Verona opera festival, an invite from a winery nearby for a wine tasting event, may be sent to the portable device of the user. According to some embodiments, coupons may also be sent to the portable device. The proposed or suggested content may be correlated with the user's taste, for example in art (opera vs. rock), the user's location and other parameters.

According to some embodiments, the proposed or suggested content may be a proposal to purchase tickets or other options based on the user's preferences or taste, based on the user's event history (e.g. the events in which the user participated in the past) and the user's location history (e.g. the places a user visited in the past or tend to visit). For example, once a user associates his portable device (for example, a user's smartphone) with a classical music concert, and the user's event history indicates that the user attends classical music events on a regular basis or frequently (e.g. once a month, at least once every quarter, more than twice in the previous 6 months, etc.), a proposal to purchase tickets for another concert or similar event, within an area visited frequently by the user (as indicated from the user's location history) may be presented to the user on the screen of the user's portable device.

According to some embodiments, end-users devices may personalize the received content items by applying user-entered parameters to control the font type, size, color, location on the screen, and/or other parameters, for the example of subtitles. According to some embodiments, different output parameters of the user device may be automatically controlled based on the event progress indication. For example, prior to the beginning of the event, the brightness of the display of the user's computerized device may be increased while during the event, the brightness of the display may be reduced. Similarly, the user device may be manually switched to a silent mode during the event by a user, and may be switched automatically back to a non-silent mode during breaks (e.g. intermissions) in the event or after the event has ended.

According to some embodiments, the administrator may allow blocking of phone calls and SMS messages in portable devices associated with the event, during the period of the show or when in geographical proximity to the event in order to avoid disturbance. In some embodiments, the blocking may be removed during a break in the occurring event, where promotional data may be received that is specific to the event. Alternatively, the content items may be interrupted by calls or messages. The device may accept a user-defined hierarchy or priority to manage conflicts between multiple concurrently operating applications.

According to some embodiments, during an education class in the university or school, the students may pre-download the content of the lesson and watch it while the teacher controls the progress of the supplemental text (or the slides). There is typically no need for special hardware like projectors in the class, since every student and the teacher may use their own mobile device or tablet. At the end of the lesson the teacher may remotely delete the content. In other embodiments, the live supplemental content may be merged or dubbed over the pre-download content to be reviewed at a later time.

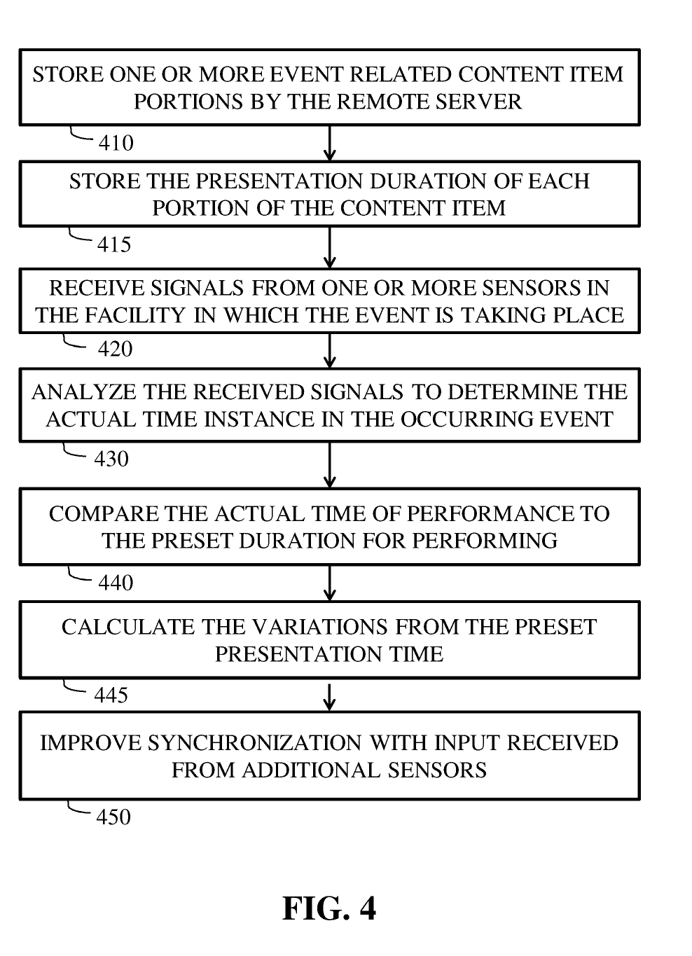

Reference is made to FIG. 4 which is a flowchart of a method for synchronizing the display of content item portions, such as slides or files, to a live occurring event in real-time, according to some embodiments of the present invention.

In block 410, a remote server (e.g., server computer 201 of FIG. 2) may store in a storage (e.g., storage 130 of FIG. 2), one or more event related content items, such as subtitles or translation of the performed language into one or more languages. Each content item may be divided into segments having a preset presentation or display duration of a predefined length, such as, for example, 4-6 seconds. Other presentation durations may be used. A plurality of portions or segments of the content item may have different presentation durations. The presentation duration of each segment may be stored in storage 130 (block 415).

According to some embodiments, a range of preset presentation duration may be assigned to each segment (e.g. a slide of subtitles), such as, for example, between 5 and 7 seconds. According to some embodiments, the preset presentation duration of each segment may be determined based on a script or a previous performance of the event to which the content item is associated.

In block 420, a facility computing device, such as device 100 in FIG. 2, may receive signals from one or more sensors in the facility in which an event is taking place. The signals may include, for example, audio recordings received from one or more microphones or other audio sensors in the facility.

In block 430, according to some embodiments, signals received from the sensor may be analyzed to determine the actual time instance in the occurring event in order to timely change the presented segment (e.g. slide or file) of the content item. For example, a voice recording of predefined length (e.g. half of the preset presentation duration of each slide) received from a microphone associated to an actor in a play, may be processed by a voice-to-text algorithm to determine the recorded text. The text may then be compared to the text of a segment of the content item to determine that the correct segment is displayed. According to some embodiments, specific words, string of words, phrases or other text portions may be searched in the text, that may be indicative of the specific segment of the content item that should be displayed and the time to change displayed segment (such as slide). The specific words or phrases searched for in a voice signal may be determined based on the preset presentation duration of each segment, the analysis time of signals received from the sensors, and the like. For example, when the currently displayed slide of subtitles includes the following text: “To be, or not to be, that is the question: Whether 'tis nobler in the mind to suffer the slings and arrows of outrageous fortune, or to take arms against a sea of troubles”, and the preset presentation duration for this slide is set to be 10 seconds, when the phrase “to be or not to be” is identified in the voice signal received from a microphone on stage, the end-user device or central server may cause the display that a first slide of subtitles associated with the “Nunnery Scene” of William Shakespeare's play Hamlet.

According to some embodiments, the audio rhythm of speaking (also referred to as the actual performance time or timing) may be determined by analyzing and comparing at least two consecutive audio recordings. For example, from a voice recording that is performed by an actor for the following text: “To be, or not to be: that is the question” several sequences may be derived. A first sequence lasting two seconds for the phrase “To be, or not” and a second sequence lasting three seconds “To be, or not to be: that is the” including the first sequence. From such sequences the timing may be derived. In the above example, within the one second difference between the two sequences the difference between the text of the first and second sequences was pronounced. Thus, the end-user device or central server may identify that it took one second to pronounce the words “to be that is the”, and the entire time elapsing from the beginning of performing the text by an actor is 3 seconds.

According to some embodiments, if the preset presentation duration for the text (e.g. “to be or not to be: that is the”) is different from the actual performance time of the same text (e.g. 3 seconds), the presentation duration of the slide or segment of the content item may be adjusted by controller 105 in accordance with this variation. For instance, if the entire slide preset presentation duration was 5 seconds, and the preset duration of the portion of the slide including the phrase “to be or not to be: that is the” was 2.5 seconds, and the actual performance time of the phrase “to be or not to be: that is the” was 3 seconds, the presentation duration of the slide may be adjusted by controller 105 to 6 seconds (assuming a proportional pace of +0.5 seconds for each preset duration of 2.5 seconds). In some embodiments, this proportional pacing may be extrapolated per slide and/or per actor (since different actors have different pacing).

In some embodiments, when a slide with text is presented to the user, the time to complete the reading of that text (e.g. by an actor on the stage) may be measured and compared to the predetermined time such that in case of deviations a corresponding deviations may apply to the presenting of the slides. In case a pause in speaking is detected (e.g. by controller 105 processing data from an audio sensor), the presentation of slides may also be paused corresponding to the occurring event.

According to some embodiments, in block 440, the actual time of performance of a phrase, such as “to be or not to be, that is the question . . . ” may be compared by controller 105 to the preset duration for performing this phrase as stored for example in storage 130, and variations from the preset presentation time of the slide may be calculated by controller 105 (block 445). According to some embodiments, the slide presentation time may be adjusted based on the calculated variation.

In block 450, input received by controller 105 from other or additional sensors may be used for improving synchronization. For example, light and sound effects may be sensed by microphones, light sensors and/or other sensors in the facility and may indicate a specific time instance of the event. Similarly, applause may be sensed by a microphone directed towards the audience and may indicate the end of a scene, an act or of the entire event. The voice changes between two actors participating in a scene may be sensed and may be indicative of the progress of the scene and the like.

Reference is made to FIG. 5 which is a flowchart of a method for synchronizing the display of content item portions, such as slides or files, to a live occurring event in real-time, based on input received via different input channels, according to some embodiments of the present invention.

In block 510, a remote server (e.g., server computer 201 of FIG. 2) may store in a storage (e.g., storage 130 of FIG. 2), one or more event related content items, such as subtitles or translation of the performed language into one or more languages. Each content item may be divided into segments having a preset presentation or display order and a predefined minimal presentation or display duration of a predefined length, such as, for example, 4-6 seconds. Other presentation durations may be used. A plurality of portions or segments of the content item may have different presentation durations and different minimal presentation duration. The presentation duration of each segment may be stored in storage 130 (block 515). The minimal presentation duration may be determined according to the time required in order to read the text (e.g. subtitles) in a the presented portion, or to listen to the audio recording (e.g. dubbing). Other parameters may be used to determine the minimal presentation duration of a portion of the content item.

In block 520, according to some embodiments, a separate input channel may be assigned to, or associated with each sensor in a facility. Thus, each of the plurality of sensors in the facility may send signals to the facility computing device via a different input channel.

As may be seen in block 525, each portion of the content item may be assigned a cue. Each cue may be associated with an input channel. For example, a signal received via a first audio channel may be a cue for a first portion and a second signal received via a second audio channel may be a cue for a second portion of the content item. According to some embodiments, each cue of a pair of consecutive cues (i.e. cues assigned to portions of the content item that are consecutive in their predefined presentation order) may be received via a different input channel.

In block 530, facility computing device may receive via a first input channel a first cue of a pair of consecutive cues, and consequently start presentation or display of the first portion (of a pair of consecutive portions) of the content item (associated with the received cue).

As may be seen in block 535, when the presentation duration of the first presented portion exceeds a predefined minimal presentation time, the facility computing device may check a second input channel, associated with the consecutive cue, for a second cue, and switch the presented portion of the content item with a consecutive portion associated with the consecutive cue (block 540).

According to some embodiments, cues may be audio signals received via audio channels and each audio channel may be associated with an audio sensor such as a microphone connected to or associated with a specific participant (e.g. actor, musician or musical instrument, opera singer and the like). Thus, it should be appreciated that cues received via different audio channels (or other sensor input channels) may be indicative of the progress of an ongoing event.

For example, each actor in a play may wear a wearable microphone and each of the wearable microphones may provide audio from one actor to the facility computing device, via a different audio channel. A quire, or any member of a quire, may be assigned a different audio channel and one or more instruments of an orchestra may be assigned a separate audio channel. For example, when a dialogue between two actors commences, a signal would be received first via a first input channel associated with the microphone of the opening actor, and when the second actor participating in the dialogue starts his part, a signal would be received via a second channel associated with the microphone of the second actor. Thus, it may be realized that the first actor finished a first segment of his part and accordingly, a new portion of the content item should be presented.

It should be appreciated that pre-recorded computer subtitles or dubbing is fixed and thereby cannot adapt to human variation in live performances. On the other hand real time speech-to-text and machine translation tools provide inaccurate results and cannot provide reliable subtitles and high quality translated dubbing. Embodiments of the present invention addresses the computer rooted challenge of real-time content presentation such as subtitles in different languages, which is synchronized with an ongoing live event, by pre-recording, pre-timing and pre-storing the pre-recorded content, on one or more end-user devices, receiving, in real time, an event progress indicator, determined based on data received from one or more sensors, such as microphones, light sensors, motion sensors and the like, located in the facility, and sending to a plurality of end-user devices associated to an ongoing event, timing markers or cues, to dynamically adjust presentation duration of pre-recorded content items, such as subtitles slides.

These method steps solve the problem of live timing with a solution that is necessarily rooted in computer technology. Embodiments of the present invention provide specific ways to dynamically adjust the pacing of discrete blocks of pre-recorded data, by using timing markers, to follow the unpredictable timing of the live performances, a problem that does not exist in manual timing of presentation of content (e.g. subtitles). Embodiments of the present invention also achieve the benefit of high quality subtitles and translation by using pre-recorded content.

Another advantage of embodiments of the present invention is that the pre-recorded content may be unrelated to the presented content, such as, for example, audio or text commentary synchronized with the live progress of the live event.

It should be further appreciated that using pre-recorded content blocks, pre-stored on end-users devices, which have already been processed and recorded, makes the facility computing device, (as well as the entire system) run faster than using real-time speech-to-text and machine translation tools e.g. for similar quality, because these tools must generate transcribed text or audio in real-time which is computationally difficult. In some cases, the work of real-time transcription cannot keep up with the pace of live performance, which can cause the supplemental content to desynchronize from the live content. By using pre-recorded content blocks, no transcription (or a minimal amount of transcription to account for live changes) occurs during the performance, minimizing the computational burden of the end-users devices. Thus, the end-users devices are more efficient and require smaller processing capabilities than conventional devices which transcribe in real time. This may allow real time communication with a plurality (e.g. hundreds) of end-user devices in a single facility, substantially simultaneously, over a network with limited bandwidth, such as a wireless local network. This may be achieved as only the timing cues or markers may be sent during a live event, indicating the timing to present each pre-recorded and pre-stored content block.

When used herein, “content” or “media content” may refer to audio, video, text subtitles in one or more languages, multi-media, commentary text and/or audio, dubbing into one or more languages and the like.

When used herein, real-time, substantially real-time, simultaneously, substantially simultaneously, or synchronized, with a live event may refer to instantly at the time of the live event or, more often, at a small time delay thereof, for example, between 0.001 and 5 or 10 seconds, and preferably less than 1 second, during, concurrently, or substantially at the same time as.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of dynamically pacing the presentation of pre-recorded supplementary content to synchronize to live content at a live event, comprising:
in one or more processor(s):
providing the pre-recorded supplementary content associated with the event to one or more end-user devices, wherein the pre-recorded supplementary content comprises an ordered sequence of content items, each timed to be played on the one or more end-user devices sequentially according to a predefined presentation time duration, and each associated with a scripted property;
receiving real-time sensor data from one or more sensors in a facility measuring a property of the live event;
matching the measured property of the live event with a corresponding scripted property to identify a live progress of the event indicated by an event progress indicator; and
sending, via a network, the event progress indicator to the one or more end-user devices to synchronize the timing of the measured properties of the live event with the timing of the pre-recorded supplementary content item associated with the matching scripted property.

2. The method according to claim 1, wherein the real-time sensor data is received every predefined time interval.

3. The method according to claim 2, wherein the time interval is shorter than the predefined presentation duration of each content item of the ordered sequence of content items.

4. The method according to claim 1, wherein each of the at least one sensor is one of a list consisting: an audio sensor, a light sensor, an image sensor, a motion sensor, and a positioning sensor.

5. The method according to claim 1, wherein the providing of the pre-recorded supplementary content associated with the event to one or more end-user devices comprises:
identifying that the at least one end-user device associated with the event is in proximity to the facility, and
downloading the pre-recorded supplementary content associated with the event to the at least one end-user device.

6. The method according to claim 5, wherein the downloaded supplementary content is automatically removed from each of the at least one end-user devices based on the progress of the event.

7. The method according to claim 1, wherein the supplementary content associated with the event is one or more supplementary content selected from a list consisting: subtitles in one or more languages, dubbing to one or more languages, and enhanced sound.

8. The method according to claim 7, further comprising:
receiving a selection of supplementary content from at least one end-user device;
identifying a location of each of the at least one end-user device;
determining preferences of at least one user associated with the at least one end-user device, based on the event, the selected type of supplementary content and the end-user device location; and
presenting suggested content according to the determined preferences, the identified location and the live progress of the event.

9. The method of claim 8, wherein presenting suggested content is further according to the at least one user preference history and location history.

10. The method of claim 8, further comprising:
assigning an input channel for each sensor;
assigning at least one cue to portions of each content item;
associating each cue with an input channel; and
initiating presentation of a portion upon receiving a cue corresponding to said portion.

11. The method of claim 10, further comprising checking input channel associated with a consecutive cue if the duration of the presentation is longer than a predefined minimal presentation time.

12. The method of claim 11, further comprising switching to presentation of a different portion when consecutive cue is received.

13. A system for dynamically pacing the presentation of pre-recorded supplementary content to synchronize to live content at a live event in at least one event facility, comprising:
at least one event facility computing device;
at least one sensor located at the event facility; and
a cloud server in active communication with the one or more facility computing devices and connectable, via a network, to a plurality of end-user devices associated with an event to take place at one of the at least one facility;
wherein the cloud server comprises a first database configured to store at least one of the pre-recorded supplementary content, and a controller configured to provide the pre-recorded supplementary content associated with the event to one or more end-user devices, wherein the pre-recorded supplementary content comprises an ordered sequence of content items, each timed to be played on the one or more end-user devices sequentially according to a predefined presentation time duration, and each associated with a scripted property; and
wherein each of the one or more facility computing devices, comprises a first processor configured to:
receiving real-time sensor data from one or more sensors in the facility measuring a property of the live event;
matching the measured property of the live event with a corresponding scripted property to identify a live progress of the event indicated by an event progress indicator; and
sending, via a network, the event progress indicator to the one or more end-user devices to synchronize the timing of the measured properties of the live event with the timing of the pre-recorded supplementary content item associated with the matching scripted property.

14. The system according to claim 11, wherein each of the at least one sensor is one of a list consisting: an audio sensor, a light sensor, an image sensor, a motion sensor, and a positioning sensor.

15. The system according to claim 11, wherein the server computer further comprises a second database, the second database configured to store suggested content.

16. The system according to claim 15, wherein the suggested content comprises one or more of: proposals for purchasing event related merchandise; proposals to purchase tickets to other events; advertisements and coupons.

17. The system according to claim 15, wherein the server computer is configured to receive from the one or more end user devices location information, and determine preferences of the at least one user, based on the event to which the end-user device of the at least one user is associated to, the supplementary content selected via the at least one end-user device, and the location of the at least one end-user device; and presenting the suggested content according to the determined preferences, the identified location and the live progress of the event.

18. The system according to claim 11, wherein the facility computing device comprises an input device configured to receive manual event progress indicators.

19. The system according to claim 11, wherein the cloud server is in active communication with at least two facility computing devices, each of the at least two facility computing devices is located in a different event facility.

20. The system according to claim 11, wherein an input channel is assigned to each sensor, and wherein presentation is initiated upon receiving a signal from at least one input channel.
